(19) United States
(12) Patent Application Publication
(10) Pub. No.: US 2011/0089294 A1
(43) Pub. Date: Apr. 21, 2011

(54) Support hanger

(76) Inventors: Donald Buytaert, Huntley, IL (US); Richard J. Ernst, San Diego, CA (US)

(21) Appl. No.: 10/616,787

(22) Filed: Jul. 10, 2003

(51) Int. Cl. F16L 3/08; F16M 13/00

(52) U.S. Cl. 248/58; 248/65

(57) ABSTRACT

A wire hanger includes a flat mounting tab connected to a spiral wire holder, well suited for attachment to an overhead surface such as a ceiling.

### BACKGROUND OF THE INVENTION

The present invention is related to hangers for supporting wires, cables, pipe, and the like. Often it is desired to support wires or the like from vertical or horizontal surfaces. For example, it may be desired to run a coaxial communications cable along a length of ceiling or wall. A hanger may be provided for attachment to the ceiling or wall for supporting the cable. Although a number of such hangers are known, unresolved problems remain.

Many known hangers include a mounting member attached to a wire receiving portion. The mounting member may be a threaded stud, for example. The threaded portion of these hangers adds to their expense. Another disadvantage of these hangers is the need to rotate the entire hanger as the threaded stud is inserted into the surface. This may prevent installation in many locations where rotation of the entire hanger is not possible, such as in a ceiling close to a wall.

Hangers have been proposed that solve some problems related to installation of a threaded mounting portion. U.S. Pat. No. 6,364,266 to Garvin, (“the '266 patent”) for example, discloses a hanger with a looped mounting terminal for receiving a stud such as a nail or a screw. This allows for the hanger to be installed without its rotation. Although the hanger of the '266 patent thus proposes a solution to one problem of the prior art, it leaves a number of additional problems unresolved.

For example, it is often desirable to install hangers on overhead surfaces such as a ceiling. This generally requires access from below the hanger. The hanger of the '266 patent uses an upper leg to distance its looped mounting terminal from its underlying wire receiving portion. This has a number of disadvantages. For example, the center of gravity of the hanger is thus located some distance from the attachment point to the ceiling or other surface. This leads to an off-center load when a wire is supported which may eventually lead to the hanger coming loose. Secondly, additional materials and machining are necessary during manufacturing to provide the upper leg.

The location of the looped terminal for mounting of the hanger of the '266 patent also gives the hanger a relatively wide profile. Because the looped mounting terminal is located beyond the periphery of the wire receiving portion, the hanger necessarily has a width that is greater than the wire receiving portion. Also, the location of the looped mounting terminal makes planning the location of the supported wire difficult. If a supported wire is desired to be located along a specified line, for instance, the nail or screw used to attach the hanger to the ceiling must be installed in the ceiling or other surface some distance from that line. Thus a plurality of measurements are required, adding time and effort to the installation process.

Additionally, the hanger of the '266 patent includes a number of elements that are attached at sharp angles to one another. An upper leg, an upright leg, a looped mounting terminal, and a wire receiving portion, for example, may all be provided. This results in a relatively “jagged” hanger which is difficult to store or package in bulk quantities. Quantities of the hanger when grouped together may become entangled and require relatively large storage and packaging containers. The configuration of the looped mounting terminal of the hanger of the '266 patent also leaves several problems unresolved. For example, the looped terminal may become “unlooped” during its service life, thereby causing the hanger to become unattached from the ceiling or wall on which it is installed.

These and other problems remain unresolved in the art.

### SUMMARY OF THE INVENTION

The present invention is directed to a wire hanger for attaching to a surface. One exemplary embodiment of the wire hanger includes a mounting portion having a hole and a spiral wire holder linked to the mounting portion. A fastener such as a screw or a nail may be used to fasten the wire holder to a surface such as a ceiling or a wall when it is inserted through the mounting portion hole and engaged with the surface. Wires, cables, or the like may then be received in the spiral wire holder. Preferably, an axis of the mounting portion hole is generally perpendicular to an axis of the spiral wire holder. This exemplary configuration provides for an advantageous balancing of load from a supported wire, and allows for access to the mounting hole from below for inserting a screw, nail, or the like.

A second exemplary embodiment of the invention is directed to a plurality of wire hangers arranged in a container, with each of the wire hangers having a mounting portion with a hole therethrough and a spiral wire receiving portion. The plurality of wire holders are arranged in a nested, stacked configuration in the container. This provides advantages related to organization and density of packaging.

### BRIEF DESCRIPTION OF THE DRAWINGS

FIG. 1 is a perspective view of one exemplary wire hanger of the invention;

FIG. 2 is a front elevational view of the wire hanger of FIG. 1;

FIG. 3 is a side elevational view of the wire hanger of FIG. 1;

FIG. 4 is a top plan view of the wire hanger of FIG. 1;

FIG. 5 illustrates a plurality of the wire hangers of FIG. 1 installed on a ceiling and supporting a wire;

FIG. 6 is a front elevational view of a second exemplary embodiment of a wire hanger of the invention;

FIG. 7 is a schematic illustration of a plurality of wire hangers of FIG. 1 stacked in a nested configuration in a container;

FIG. 8 is a side elevational view of an additional wire hanger embodiment of the invention that includes a moveable gate;

FIG. 9 is a top plan view of the wire hanger of FIG. 8;

FIG. 10 is a perspective view of the wire hanger of FIG. 1 with a fastener held in place by a fastener holder;

FIG. 11 is a expanded view of a portion of FIG. 10; and,

FIG. 12 shows the exemplary wire hanger of FIG. 10 held on an installation tool.

### DETAILED DESCRIPTION OF THE INVENTION

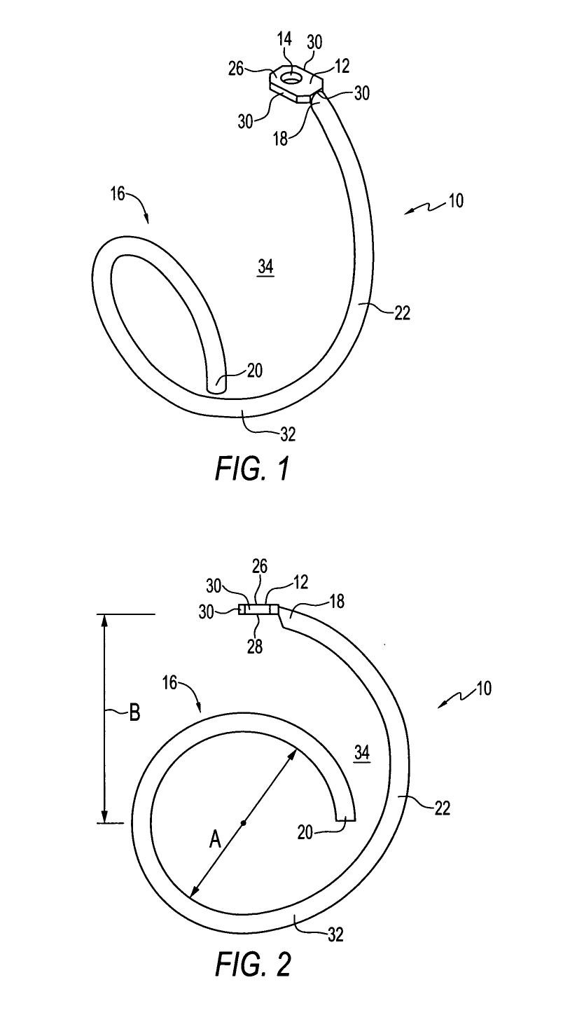

Referring now to FIGS. 1-4, one exemplary embodiment of the wire hanger of the invention is shown generally at 10. The wire hanger 10 includes a generally rectangular-shaped mounting tab 12 with a hole 14 therethrough. A spiral wire holder shown generally at 16 is connected to the mounting tab 12. The spiral wire holder 16 includes a first end 18 that is connected to the mounting tab 12, a second end 20 distal from the first, and a middle portion 22 that spans the first and second ends 18 and 20.

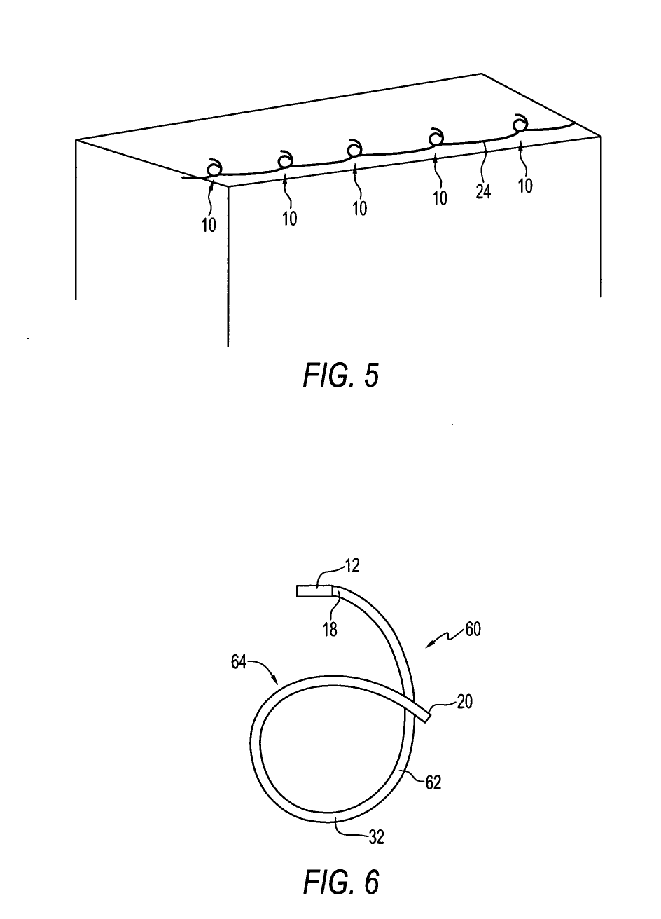

In operation, the wire hanger 10 may be installed by inserting a fastener such as a screw or a nail through the mounting tab hole 14 to engage a ceiling or a wall to mount the wire hanger 10 thereto. A wire or a cable may then be received in the spiral wire holder 16. By way of example, FIG. 5 illustrates a plurality of wire hangers 10 installed along a ceiling, with a wire 24 supported by the hangers 10.

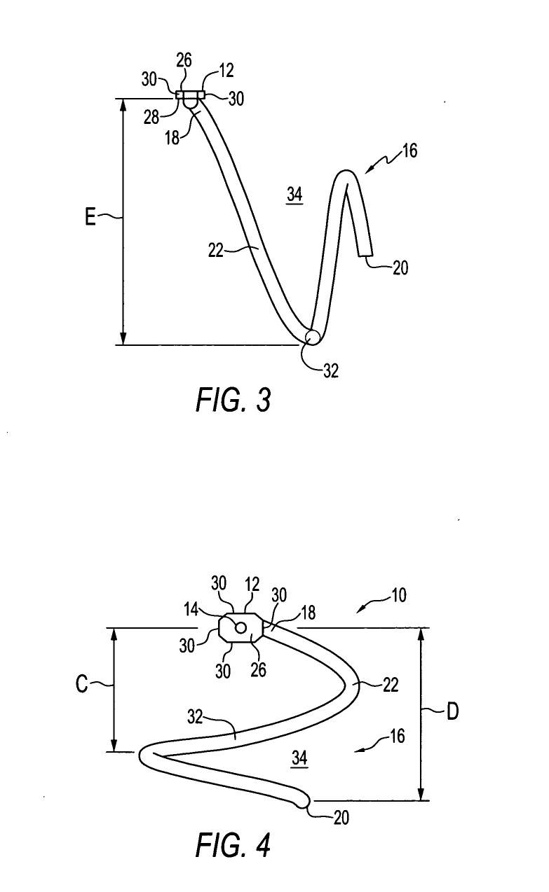

Referring again to FIGS. 1-4, the mounting tab 12 includes two opposite generally planar surfaces 26 and 28 (FIGS. 2-3) that the hole 14 extends through, as well as four generally straight side edges 30. The spiral first end 18 is connected to the mounting tab 12 along one of the straight side edges 30. In a most preferred configuration, the mounting tab 12 and the spiral 16 are comprised of cold rolled steel, and are integral with one another. As used herein, the term “integral” is intended to be broadly interpreted as meaning substantially continuous and uniform in composition. By way of example, two parts may be integral with one another if they are formed simultaneously of the same material.

In the case of the mounting tab 12 and spiral wire holder 16, the two elements may be made of cold rolled wire, for example, with the mounting tab 12 flattened and cut to provide its rectangular shape. Such a configuration has been found to be advantageous for manufacturing efficiency, material strength, and like reasons. Selection of materials of construction for the wire holder 10 will depend on application design considerations such as desired weight, strength, durability, and the like. Use of cold rolled steel is believed to offer a relatively advantageous balance of cost, machinability, strength, and weight for many applications. Cold rolled steel wire having a diameter of between about 0.15 and about 0.25 inches is believed to be particularly well-suited for many applications.

Other materials may also be useful, with examples including polymers such as plastics and the like.

In the exemplary steel mounting tab 12, the hole 14 is preferably formed by penetrating the flattened tab 12 with a tool such as a punch. The mounting tab 12 provides many advantages over the prior art. The generally planar tab surface 26, for example, provides for a relatively strong frictional engagement with an engaged surface such as a wall, ceiling or the like. In a similar manner the tab planar surface 28 provides for good engagement with a screw, nail, or other fastener head. Further, because the hole 14 is punched through the tab 12, chances for it to become “unwound” as could occur using looped terminals of the prior art are substantially eliminated.

In order to provide good frictional engagement with the ceiling, wall, or other mounting surface, and the fastener head, a surface area of at least about 0.5 square inches is believed useful for the tab surfaces 26 and 28. Sizes above about 1 square inch for the surfaces 26 and 28 are believed to offer little advantage for most applications, with the result that an area of between about 0.5 and about 1 square inch are believed most useful. It will be appreciated that other areas are also contemplated, and that other mounting portions in addition to the mounting tab 12 are also contemplated in the practice of the invention. Polygonal shapes having one or more straight edges are preferred.

As best illustrated by the views of FIGS. 2-4, the spiral wire holder 16 is non-planar and preferably comprises a generally decreasing radius from its first end 18 to its second end 20. The generally decreasing radius can be appreciated in the elevational view of FIG. 2 looking along the axis of the spiral wire holder 16 where the spiral second end 20 lies generally inside of the spiral middle portion 22. This has been found to be advantageous for inserting a wire that runs generally along the spiral's axis into the spiral wire holder 16.

The spiral wire holder 16 preferably extends for between about 1 and about 1.5 rotations from its first end 18 to its second end 20. This is evident by the view of FIG. 2 along the axis of the spiral wire holder 16, where the spiral first end 18 is located at about 0° and the middle portion 22 extends for about 450° to terminate in the second end 20 at about 90° (i.e., 450°-360°) relative to the first end 18. The spiral wire holder 16 is thus non-planar, as best illustrated by the views of FIGS. 3-4. This has been discovered to be advantageous for a number of reasons. For example, it has been discovered that this configuration allows for good access to the mounting tab hole 14 from below when inserting a fastener through the hole 14 to attach the wire holder 10 to an overhead surface such as a ceiling.

The spiral holder 16 includes a base region 32 that is generally opposite of the mounting tab 12 when viewed along the axis of the spiral wire holder 16 as shown by FIGS. 1-3. When the wire holder 10 is in a vertical position with the mounting tab 12 uppermost, as is the case when it is attached to a ceiling, the base region 32 is generally oriented at the bottom of the spiral holder 16. In this orientation the base region 32 will support the wire held in the spiral wire holder 16.

In the exemplary embodiment of FIGS. 1-4, the final about ½ to 1 rotation of the spiral wire holder 16 is generally circular and has a diameter of A (FIG. 2), and the axial center of the generally circular spiral wire holder 16 is spaced vertically from the mounting portion 12 by a distance B (FIG. 2). With reference to FIG. 4, base region 32 is spaced from the mounting portion 12 along the axis of the spiral holder 16 by a distance C, and the spiral second end 20 is spaced a distance D that is at least about from the mounting portion 12. The following dimensions for A, B, C, and D are believed to offer an advantageous and beneficial result for practice of the invention:

| | Dim. A | | Dim. B | Dim. C | | Dim. D |
|---|---|---|---|---|---|---|
| Example Hanger 1 | 1.5 | in. | 2.33 in. | 1.625 | in. | 2.475 in. |
| Example Hanger 2 | 2 | in. | 4.33 in. | 1.625 | in. | 2.475 in. |
| Example Hanger 3 | 4 | in. | 4.33 in. | 2 | in. | 2.85 in. |

It has been discovered that dimensions of A, B, C, and D of these magnitudes allow for access to the mounting portion hole 14 using a power tool such as a drill, or a pneumatic or combustion powered tool such as a powder gun. Also, it will be appreciated that the base region 32 is spaced vertically from the mounting portion 12 by a vertical distance of E=(½ A+B) (FIG. 3). A wire receiving gap 34 is defined between the spiral wire holder second end 20 and the middle portion 22. Distances E of between about 3 in. and about 6 ⅓ in. have been discovered to provide useful access for inserting wires to the spiral wire holder 16 through the gap 34, and yet provide an acceptably compact profile for the wire hanger 10. Distances D that are less than twice the distance C have also been discovered to be advantageous for purposes of inserting and supporting wires. Other values for the dimensions A, B, C and D than those shown and discussed are also contemplated.

As best shown by the view of FIG. 2, the base region is generally in line with the mounting tab 12 along the axis of the mounting tab hole 14 that is generally transverse to the axis of the spiral wire holder 16. This provides advantages related to generally centering a load along the axial direction of the spiral wire holder 16. This also provides advantages for installation of wire hangers 10. By way of example, if a wire is desired to be hung along a particular line, that line may be drawn on the ceiling or other surface and fasteners inserted through the mounting portion hole 14 on that line. Because the base portion 32 is generally vertically directly below the mounting portion 32, the wire will be supported at this point.

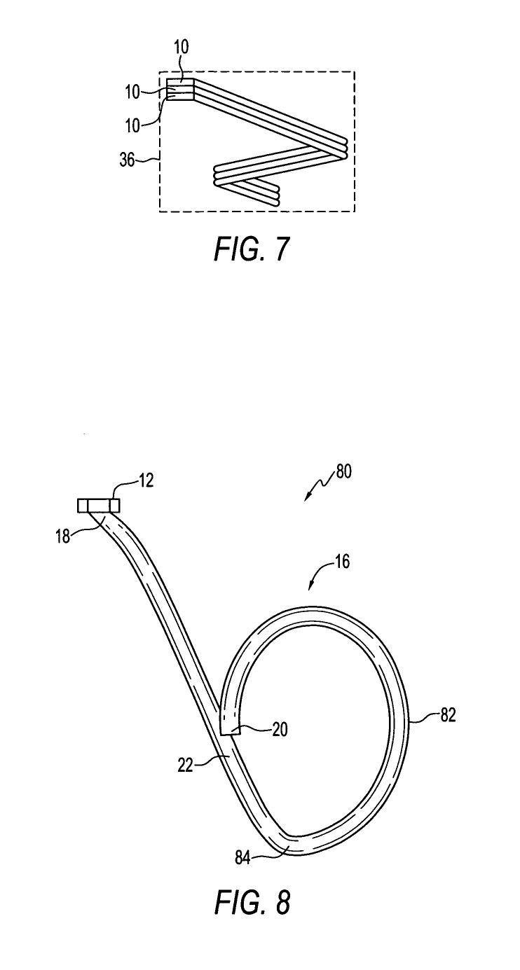

The wire hanger 10 also achieves valuable advantages due to its generally spiraled configuration that are related to packaging and storage. For example, the spiral wire holder 16 allows for wire hangers 10 of the invention to be nested in one another and stacked. FIG. 7 shows a plurality of wire hangers 10 nested and stacked in a container 36 which may be a commercial package, a shipping container, or a storage container, by way of example. This nested stacking provides for a relatively high density of packing for commercial packaging and for storage by users. An additional embodiment of the invention is directed to a plurality of nested wire hangers 10 held in a package as generally illustrated in FIG. 7.

It will be appreciated that the wire hanger 10 of FIGS. 1-5 represents one exemplary embodiment only, and that many additional wire hanger embodiments are contemplated within the scope of the present invention, and may be preferred for particular applications. By way of example, an additional wire hanger embodiment may include additional elements between the mounting portion and the spiral wire holder. That is, an additional embodiment of the invention may include a mounting portion that is linked to a spiral wire holder, but is not directly connected as is the case for the wire hanger 10. By way of additional example, FIG. 6 shows an elevational view of a second wire hanger embodiment 60 that is consistent in many ways with the wire hanger 10. In illustrating the wire hanger 60 identical element numbers to the embodiment 10 of FIGS. 1-5 have been used to describe consistent elements.

One important difference of the wire hanger 60 as compared to the wire hanger 10 is that its spiral wire holder middle portion 62 is configured so that the spiral second end 20 extends beyond the spiral middle portion 62 when viewed along the axis of the spiral wire holder 64 as shown by FIG. 6. With this configuration, a wire being inserted into the spiral wire holder 64 must be bent or twisted around the spiral second end 20. This will offer decreased chances of the wire once inserted from becoming accidentally disengaged.

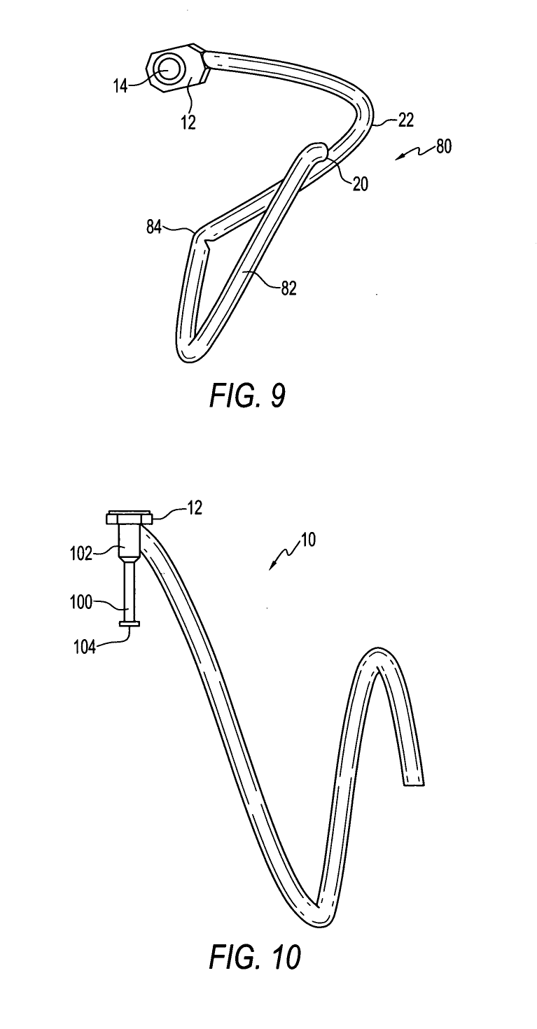

In a third exemplary embodiment of a wire hanger of the invention, the spiral wire holder 16 includes one or more hinged sections to define a movable gate that can be pivotably moved to close the receiving gap. FIGS. 8 and 9 illustrate this exemplary third invention embodiment generally at 80, with FIG. 8 showing a side elevational view similar to the view of FIG. 3, and FIG. 9 showing top plan view similar to the view of FIG. 4. The wire hanger 80 is similar to the wire hanger 10, with identical element numbers used to describe similar elements.

The wire hanger 80 differs from the hanger 10 in that a movable gate 82 is defined within the spiral wire holder 16 middle portion 22 between a hinged section 84 and the spiral wire holder second end 20. Movement of the movable gate 82 causes the spiral second end 20 to move toward the spiral middle portion 22 to effectively close the wire receiving gap 34. The second end 20 may be moved into engagement with the middle portion 22, or may be left proximate to it. It will be appreciated that this third exemplary embodiment may appear consistent with the wire holder 10 of FIG. 1 when the spiral wire holder movable gate 82 and second end 22 are in an un-bent position.

One or more hinged sections 84 may be included, with each comprising one or more V notches cut into the spiral wire holder middle portion 22 to facilitate pivotable movement of the second end 20. The one or more hinged sections 84 may be located in any of a multitude of positions along the spiral middle portion 22. Preferably the open end of the “V” notch that defines the preferred hinged section is oriented away from the interior of the spiral holder 16 to avoid potentially pinching wires as the gate 82 is moved.

In yet an additional aspect of the present invention, a coating layer may be provided on at least a portion of the surfaces of a wire hanger of the invention such as the hanger 10, 60 or 80. A polymer or similar layer over the surface of the wire hanger may be beneficial to provide electrical resistance and mechanical protection against wearing of wire surfaces, and/or to reduce friction as a wire is pulled through the spiral holder. The protective coating may be provided on an interior surface of the spiral wire holder 16 (FIGS. 1-4) for instance, or may be provided on the entire wire hanger 10. It may prove economical, for instance, to apply a coating to substantially all of the hanger 10 through immersion, spraying, or the like.

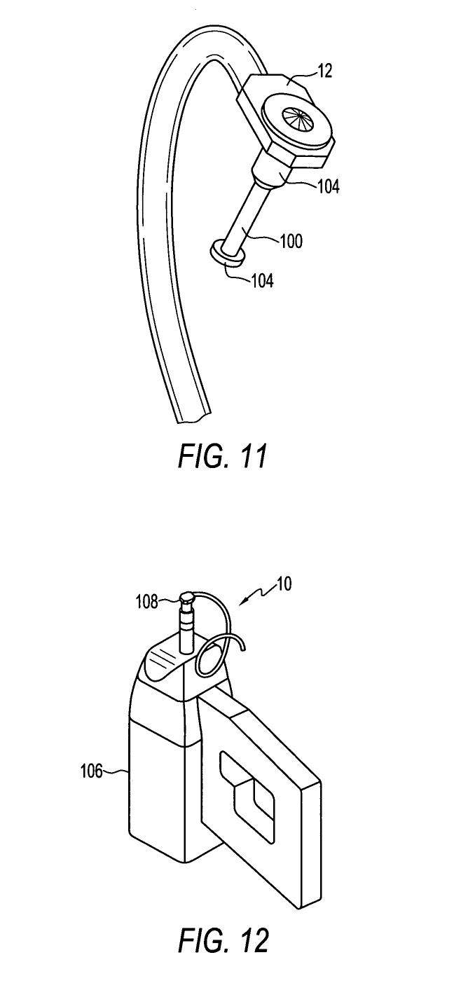

FIGS. 10 and 11 illustrate still an additional aspect of the invention. In particular, a fastener 100 has been provided attached to the wire hanger 10 using a holder 102. The fastener 100 may comprise a nail or the like. The holder 12 may comprise a metal or plastic collar configured to frictionally hold the fastener 100 in place in the mounting hole 14. The holder 12 may further be configured to position the fastener head 104 for being engaged in an installation tool.

The held-in-place fastener 100 shown in FIGS. 10 and 11 provide valuable advantages for one-handed installation of the wire hanger 10 in a surface such as an overhead ceiling. FIG. 12, for example, illustrates a wire hanger 10 held on a nail gun 106. The fastener 100 that is positioned by the holder 102 is useful when inserted in the barrel 108 of the nail gin 106 to retain the wire hanger 10 on the nail gun 106. The nail gun 106 may then be operated using one hand, with the wire hanger 10 positioned against a surface as desired. The fastener 100 is preferably positioned by the holder 102 such that the fastener 100 does not extend all the way through the mounting hole 14. This allows the wire hanger to be placed flush against a surface. Actuating the nail gun 106 causes the fastener 100 to be inserted through the mounting hole 14 and into the ceiling. The holder 102 either breaks apart leaving the fastener head 104 engaging the mounting tab 12, or is flattened and held between the head 104 and the mounting tab 12.

Embodiments of the present invention thus provide a wire hanger that offers many advantages and solves many problems of the prior art. While particular embodiments of the present wire hanger of the invention have been shown and described, it will be appreciated by those skilled in the art that changes and modifications may be made thereto without departing from the invention in its broader aspects and as set forth in the following claims.

1. A support hanger for attaching to a flat mounting surface comprising:
a mounting portion having a hole therethrough;
a spiral wire holder having first and second ends and a middle portion, said first end linked to said mounting portion.

2. The support hanger of claim 1 wherein said mounting portion includes two generally planar opposite surfaces, said hole extending between said two generally planar surfaces.

3. The support hanger of claim 1 wherein said mounting portion has at least one generally planar surface with an area of at least about 0.5 square inches for abutting said flat mounting surface.

4. The support hanger of claim 1 wherein said mounting portion is generally polygonal-shaped and has a plurality of generally straight side edges.

5. The support hanger of claim 1 wherein said mounting portion is connected to said first end of said spiral wire holder.

6. The support hanger of claim 1 wherein said mounting portion is integral with said spiral wire holder.

7. The support hanger of claim 1 wherein said mounting portion comprises flattened metal, and wherein said hole is defined by a generally circular penetration through said flattened metal.

8. The support hanger of claim 1 wherein said mounting portion comprises a generally polygonal-shaped tab with two opposite planar surfaces and a plurality of generally straight side edges, said hole extending between said two opposite planar surfaces, each of said two planar surfaces having an area of between about 0.5 square inches and about 1 square inch.

9. The support hanger of claim 1 wherein said spiral wire holder includes a wire-receiving gap.

10. The support hanger of claim 1 wherein said spiral wire holder has a base region that is separated from said mounting portion by a vertical distance of not more than about 6 ⅓ inches.

11. The support hanger of claim 1 wherein the flat mounting surface is an overhead surface, wherein said mounting portion hole has an axis, and wherein said spiral wire holder has an axis and has a base region that is generally in line with said hole axis when the support hanger is viewed along said spiral wire holder axis.

12. The support hanger of claim 1 wherein the mounting surface is an overhead surface, wherein said spiral wire holder has an axis and a base region that is spaced at least about 1 ⅝ inches along said spiral wire holder axis from said spiral wire holder first end.

13. The support hanger of claim 1 wherein the mounting surface is an overhead surface, wherein said spiral wire holder has a base region configured to be spaced at least about 3 inches from the overhead mounting surface.

14. The support hanger of claim 1 wherein said mounting portion hole has an axis, and wherein said spiral wire holder has an axis generally perpendicular to said hole axis.

15. The support hanger of claim 1 wherein said spiral wire holder extends for between 1 and about 1.5 rotations.

16. The support hanger of claim 1 wherein said spiral wire holder has an axis, and said spiral wire holder first end is configured to be located at about 180° from and said second end when the support hanger is viewed along said spiral wire holder axis.

17. The support hanger of claim 1 wherein said spiral wire holder has an axis, and wherein said second end is spaced at least about 2.475 inches along said axis from said first end.

18. The support hanger of claim 1 wherein said spiral wire holder has a generally decreasing radius from said first end to said second end.

19. The support hanger of claim 1 wherein said spiral wire holder has an axis and wherein said spiral wire holder second end extends across said middle portion when the support hanger is viewed along said axis.

20. The support hanger of claim 1 wherein said spiral wire holder is configured for nesting engagement with a spiral wire holder of a second support hanger.

21. The support hanger of claim 1 wherein said mounting portion and said spiral wire holder are integral with one another and formed of cold rolled steel.

22. The support hanger of claim 21 wherein said cold rolled steel comprises wire having a diameter of between about 0.15 and about 0.25 inches.

23. The support hanger of claim 1 wherein said spiral wire holder middle portion includes a movable gate terminating in said second end.

24. The support hanger of claim 1 wherein said spiral wire holder defines a wire receiving gap, and wherein said spiral wire holder middle portion includes one or more hinged sections to define a movable gate between said one or more hinged sections and said spiral second end, said movable gate for effectively closing said wire receiving gap.

25. The support hanger of claim 1 and further including a holder frictionally engaged in said mounting portion hole.

26. The support hanger of claim 25 wherein said holder includes a fastener held in position for insertion into the barrel of a fastener inserting tool.

27. The support hanger of claim 25 wherein said holder includes a fastener held in a position wherein an end of the fastener does not extend through said mounting hole.

28. The support hanger as defined by claim 1 and further including a coating layer over at least a portion of the surface of said spiral wire holder.

29. A support hanger for attaching to a flat overhead surface, the hanger comprising:
a mounting tab having a pair of opposing generally planar surfaces and a plurality of generally straight side edges, a hole extending between said opposing generally planar surfaces and having an axis; and
a spiral wire holder having first and second ends and a middle portion, said spiral wire holder integral with said mounting tab and connected at said first end thereto, said spiral wire holder having an axis and a base region, said base region generally along said hole axis, said base region configured to be spaced at least about 3 inches below the overhead surface, said spiral extending for between about 1 and about 1.5 rotations.

30. A plurality of support hangers arranged in a container, each of said support hangers comprising a mounting tab having a plurality of substantially straight sides and a hole therethrough, a spiral wire holder linked to said mounting tab, said spiral wire holder of each of said support hangers nested in a spiral wire holder of an underlying of said plurality of support hangers whereby said plurality of support hangers form a nested stack in said container.

31. A plurality of support hangers as defined by claim 30, wherein each of said spiral wire holders extends for between about 1 and about 1.5 rotations.

32. The support hanger of claim 1 wherein said spiral wire holder has a base region that is separated from said mounting portion by a vertical distance of at least about 3 inches and is formed of cold rolled steel with a diameter of between about 0.15 and about 0.25 inches.

33. The support hanger of claim 1 wherein said spiral wire holder is generally circular and has a diameter of at least about 2 in.

34. The support hanger of claim 19 wherein said spiral wire holder is substantially circular.
